(19) United States
(12) Patent Application Publication
(10) Pub. No.: US 2013/0283335 A1
(43) Pub. Date: Oct. 24, 2013

(54) SYSTEMS AND METHODS FOR APPLYING POLICY WRAPPERS TO COMPUTER APPLICATIONS

(71) Applicants: Karthik LAKSHMINARAYANAN, Cupertino, CA (US); Joseph SAIB, Santa Clara, CA (US)

(72) Inventors: Karthik LAKSHMINARAYANAN, Cupertino, CA (US); Joseph SAIB, Santa Clara, CA (US)

(73) Assignee: APPSENSE, INC., New York, NY (US)

(21) Appl. No.: 13/450,698

(22) Filed: Apr. 19, 2012

(51) Int. Cl. G06F 21/00

(52) U.S. Cl. 726/1

(57) ABSTRACT

Systems and methods are provided that allow an enterprise to apply a policy wrapper to any computer application. The use of a policy wrapper allows for any enterprise user to securely communicate with an enterprise, or generally communicate over a communication network, at a computer application level. A policy wrapper includes policies that can specify how to handle different types of API calls associated with a computer application, such as the re-routing, modification, or recording of IP packets, the storage of data, the displaying of data, the printing of data, or any other suitable data and/or actions. The policies can treat the different types of data and/or actions the same or differently. The policies can further distinguish between a user's enterprise-related information and the user's personal information, and specify the locations to which the information should be directed.

### BACKGROUND

1. Technical Field

Disclosed systems and methods relate to the use of policy wrappers for computer applications.

2. Description of the Related Art

Traditionally, enterprises or businesses set up their own enterprise network to allow their users to access computer applications, to access the Internet, to communicate with one another, to store and access files from an enterprise storage, to print files, and to share other network resources. An enterprise will often have a main office location and one or more remote office locations. The main office location typically provides the enterprise network. The different remote office locations are able to connect to the enterprise network at the main office location over a public communication network such as the Internet. In addition, users who are working away from the main office location and the different remote office locations can also remotely connect their computers to the enterprise network at the main office location over the Internet.

Security is a major concern for enterprises that allow remote office locations and remote users to connect to the enterprise network at the main office location over the Internet. Enterprises need to be able to provide a secure network in order to keep data that its users generate, send, receive, and/or access confidential. In particular, any data exchanged over the Internet among the main office location, the remote office locations, and the remote users needs to be protected to prevent unauthorized users from intercepting this data.

One known approach to provide an enterprise with a secure network is to use a virtual private network (VPN). The VPN allows remote office locations and remote users to securely connect to, and communicate with, an enterprise network at the main office location. The VPN requires that the remote office locations and remote users be authenticated before connecting to the enterprise network at the main office location. In addition, the VPN provides a firewall and applies encryption techniques to data that is to be exchanged over the Internet. This data is in the form of IP packets. The VPN provides security by re-routing these IP packets through a trusted route over the Internet to the enterprise network.

The VPN has limitations. For an enterprise, implementing the VPN is invasive and difficult to set up correctly. In addition, the VPN only re-routes IP packets. Furthermore, the VPN re-routes IP packets in the same way to the same destination for all computer applications operating on a given computer.

Therefore, there is a need in the art to provide more flexibility in the types of information being securely exchanged over the Internet, and which can be customized for different computer applications. In particular, there is a need in the art to provide systems and methods for the use of policy wrappers for computer applications.

Accordingly, it is desirable to provide methods and systems that overcome these and other deficiencies of the related art.

### SUMMARY

In accordance with the disclosed subject matter, systems and methods are provided for the use of policy wrappers for computer applications.

Disclosed subject matter includes a non-transitory computer readable medium having executable instructions. The executable instructions are operable to cause a client device to receive an application programming interface (API) call to communicate information from a computer application to an enterprise over a communication network and to determine whether the computer application has associated with it a policy wrapper comprising a policy that specifies how to handle the API call from the computer application. When the computer application has the policy wrapper associated with it, the executable instructions are further operable to cause the client device to retrieve the policy for the policy wrapper associated with the computer application and to implement the API call by securely communicating the information from the computer application to the enterprise over the communication network based on the policy.

Disclosed subject matter includes an apparatus comprising one or more interfaces configured to provide communication with an enterprise via a communication network; and a processor, in communication with the one or more interfaces, and configured to run a module stored in memory. The module is configured to receive an application programming interface (API) call to communicate information from a computer application to the enterprise over the communication network and to determine whether the computer application has associated with it a policy wrapper comprising a policy that specifies how to handle the API call from the computer application. When the computer application has the policy wrapper associated with it, the module is further configured to retrieve the policy for the policy wrapper associated with the computer application and to implement the API call by securely communicating the information from the computer application to the enterprise over the communication network based on the policy.

Disclosed subject matter includes a method comprising receiving an application programming interface (API) call to communicate information from a computer application to an enterprise over a communication network and determining whether the computer application has associated with it a policy wrapper comprising a policy that specifies how to handle the API call from the computer application. When the computer application has the policy wrapper associated with it, the method further comprises retrieving the policy for the policy wrapper associated with the computer application and implementing the API call by securely communicating the information from the computer application to the enterprise over the communication network based on the policy.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system.

FIG. 2 illustrates a client device using a virtual private network in a networked communication system.

FIG. 3 illustrates a diagram of a networked communication system in accordance with certain embodiments of the disclosed subject matter.

FIG. 4 illustrates a diagram of the use of a policy wrapper for a computer application in accordance with certain embodiments of the disclosed subject matter.

FIG. 5 illustrates a diagram of the use of policy wrappers for two computer applications in accordance with certain embodiments of the disclosed subject matter.

FIG. 6 illustrates a diagram of a networked communication system implementing policy wrappers for computer applications in accordance with certain embodiments of the disclosed subject matter.

FIG. 7 illustrates a flow diagram illustrating how policy wrappers are applied to computer applications in accordance with certain embodiments of the disclosed subject matter.

FIG. 8 illustrates a flow diagram illustrating how policy wrappers are applied to computer applications in accordance with certain embodiments of the disclosed subject matter.

FIG. 9 illustrates a block diagram of a client device in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The disclosed subject matter relates to systems and methods for providing policy wrappers to computer applications. An enterprise can apply a policy wrapper to any computer application provided to an enterprise user. A policy wrapper includes a set of policies (e.g., rules, requirements, restrictions, instructions, guidelines, conditions) for how to handle different application programming interface (API) calls from a computer application. The policies can specify requirements for the authentication of an enterprise user, a user's computing device, and/or a remote office location before accessing a computer application and/or implementing an API call from the computer application. The policies can provide a firewall and/or apply encryption techniques to the information from the API calls that is to be communicated over the Internet. The policies can specify how to handle different types of API calls, such as the re-routing, modification, or recording of IP packets, the storage of data, the displaying of data, the printing of data, or any other suitable data and/or actions. The different types of data and/or actions can be treated the same or differently. The policies can further distinguish between a user's enterprise-related information and the user's personal information, and specify the locations to which the information should be directed. The different types of information can be re-routed to the same or different locations. The policies can further specify that any enterprise-related information be re-routed only to an enterprise-authorized resource, such as an enterprise server, client (computing device), storage (e.g., a physical storage medium, cloud storage, database), printer, photocopier, website, or any other suitable network resource or combination of network resources. Any other suitable policy or combination of policies can be provided in the policy wrapper.

In accordance with the disclosed subject matter, the policy wrapper can be specified and/or provided by any suitable party or combination of parties. The party can be an enterprise, an enterprise user, a provider of a computer application, or an authorized third-party. In one embodiment, there can be one policy wrapper associated with a computer application. The policy wrapper can be provided by one party or a combination of different parties. In another embodiment, there can be more than one policy wrapper associated with a computer application. Each policy wrapper can be provided by one party or a combination of parties. One or more policy wrappers may be applied to a computer application, which can depend on the user, the enterprise to which the user desires to communicate with, and/or the type of information to be communicated. In one embodiment, a different policy wrapper or combination of policy wrappers can be applied to different computer applications. In another embodiment, a common policy wrapper or combination of policy wrappers can be applied to different computer applications. In yet another embodiment, a policy wrapper can be applied to a suite of computer applications. In a further embodiment, the same or different policy wrapper can be applied to the same computer application that is installed on different computing devices.

In accordance with the disclosed subject matter, the policy wrapper can be applied to any suitable computer application or combination of computer applications to which an enterprise provides to a user, allows a user to have access, and/or installs on a user's computing device. For example, the computer application can include any text program (e.g., Microsoft Word), presentation program (e.g., Microsoft PowerPoint), spreadsheet program (e.g., Microsoft Excel), electronic-mail (e-mail) communication program (e.g., Microsoft Outlook), Instant messaging (IM) program, document management system (e.g., iManage, Worksite), application software for files (e.g., Adobe Acrobat), graphics editing program (e.g., Adobe Photoshop), time entry system (e.g., DTE, Carpe Diem), web browser (e.g., Internet Explorer, Safari, Mozilla Firefox), software developer tool, games, mobile application (e.g., Dropbox, Evernote), or any other suitable computer application or combination of computer applications. The computer application can also include any suitable application for a Windows, Mac, Linux, Unix, iOS, Windows Phone, Android-based operating system, or any other suitable operating system. The computer application can also include any suitable application for a desktop computer, mobile computer, tablet computer (e.g., iPad, Android-based tablet, Nook Tablet, Kindle Fire), cellular device (e.g., a smartphone such as a Blackberry, iPhone, Android-based smartphone), or any other suitable computing device. The computer application can further include any suitable application that a user can access through the web browser (e.g., e-mail program such as Gmail).

In accordance with the disclosed subject matter, the enterprise user can be any user or device authorized to access the enterprise network. The authorized user can include an employee, consultant, independent contractor, and third-party service provider. The user can access the enterprise network using a computing device. The computing device can be a work-issued or personal device such as a desktop computer, a mobile computer, a tablet computer, and a cellular device. In order to be able to access a computer application that needs access to the enterprise network, the user may first need to be authenticated. The user may first have to enter log-in credentials, including a user name, password, key, and/or any other suitable information or combination of information. In one embodiment, the user may have to enter log-in credentials once. In another embodiment, the user may have to enter log-in credentials each time the user opens a computer application that has an associated policy wrapper.

In accordance with the disclosed subject matter, a policy wrapper can be applied to any computer application at any time. In one embodiment, a policy wrapper can be applied to a computer application before the computer application is sold or licensed to an enterprise. In another embodiment, a policy wrapper can be applied to a computer application before the computer application is installed on the enterprise network and/or on a user's computing device. In yet another embodiment, a policy wrapper can applied to a computer application after the computer application has been installed on a user's computing device. A software update can be sent, or downloaded, to the user's computer device, which is then installed and associated with a computer application. This can be done automatically, may require a user to authorize the installation, and/or may require an enterprise network administrator to authorize the installation.

In accordance with the disclosed subject matter, a policy wrapper can be software, hardware, or a combination of software and hardware. In one embodiment, the software for the policy wrapper can be integrated with the software for the computer application. In another embodiment, the software for the policy wrapper can be separate from the software for the computer application, but include a link that associates the policy wrapper with the computer application.

The disclosed subject matter provides advantages for enterprises and the enterprise user. The use of policy wrappers for computer applications provides a secure way for remote office locations and remote users to securely communicate with the enterprise network at the main office location or via an enterprise cloud. This approach is less invasive and easier to set up correctly than for the virtual private network (VPN). This approach also provides more flexibility in the types of information that can be securely exchanged over the Internet. For example, this approach allows the re-routing, modification, or recording of IP packets, the storage of data, the displaying of data, the printing of data, or any other suitable data and/or actions. This approach can also be customized for different API calls, for different computer applications, and/or for different computing devices. For example, different computer applications can have different types of information being re-routed to different locations. This approach can also distinguish between a user's enterprise-related information and the user's personal information, and re-route the information to different locations accordingly.

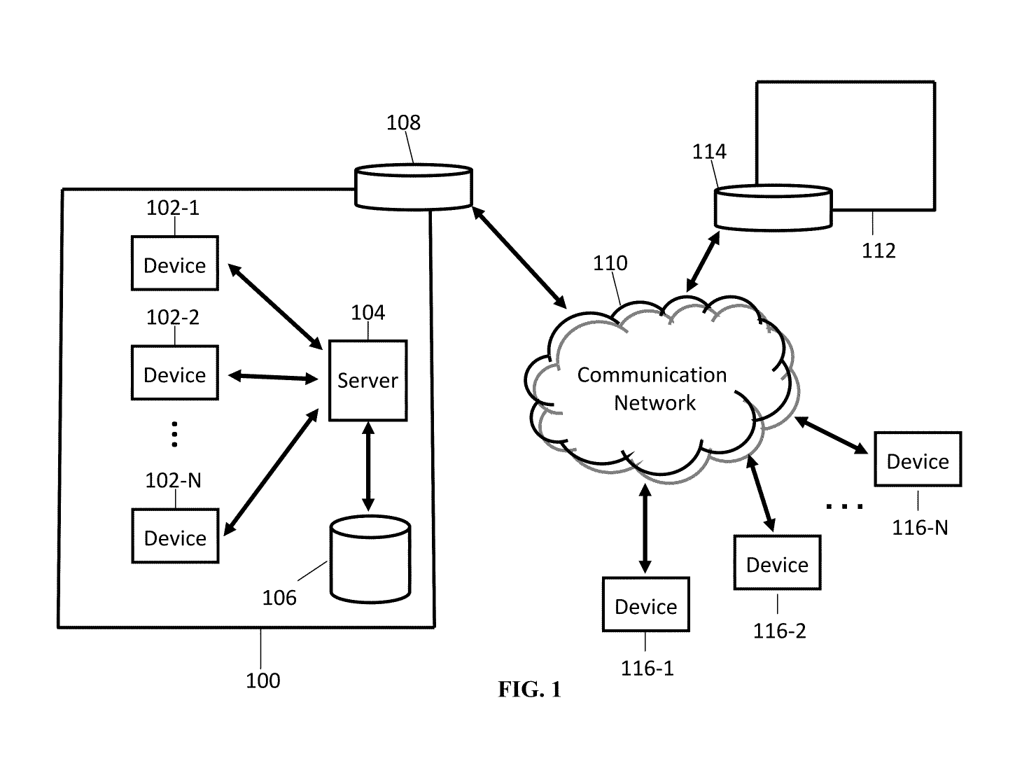

FIG. 1 illustrates a diagram of a networked communication system for an enterprise that uses VPN. FIG. 1 includes an enterprise main office 100, an enterprise remote office 112, at least one device 116 (e.g., device 116-1, 116-2, . . . 116-N), and a communication network 110.

The enterprise main office 100 includes at least one device 102 (e.g., device 102-1, 102-2, . . . 102-N), an enterprise server 104, at least one physical storage medium 106, and a VPN server or appliance 108. In one embodiment, each device 102 can be any suitable client device that allows any enterprise user to directly connect to the enterprise network. Each device 102 can include a desktop computer, a mobile computer, a tablet computer, a cellular device, or any other computing device having a processor and memory. In another embodiment, one or more of the devices 102 can include a network resource to which an enterprise user can connect, including a printer, a photocopier, or any other network resource having a processor and memory.

Each device 102 can communicate with the enterprise server 104 to send data to, and to receive data from, another device 102 and/or other network nodes (including devices at the enterprise remote office 112 and/or device 116) across the communication network 110. Although FIG. 1 shows each device 102 being directly coupled to the enterprise server 104, each device 102 can be connected to the enterprise server 104 via any other suitable device, communication network, or combination thereof. For example, each device 102 can be coupled to the enterprise server 104 via one or more routers, switches, access points, and/or communication networks (as described below in connection with communication network 110).

The enterprise server 104 is coupled to at least one physical storage medium 106 for the enterprise. Any enterprise user, from enterprise main office 100 (using any device 102), from enterprise remote office 112, and device 116, can store data in, and access data from, the physical storage medium 106 via the enterprise server 104. FIG. 1 shows the enterprise server 104 and the physical storage medium 106 as separate components; however, the enterprise server 104 and physical storage medium 106 can be combined together. FIG. 1 also shows the enterprise server 104 as a single server; however, the enterprise server 104 can include more than one enterprise server. FIG. 1 shows the physical storage medium 106 as a single physical storage medium; however, the physical storage medium 106 can include more than one physical storage medium. The physical storage media can be located in the same physical location as the enterprise main office 100, at the same physical location remote from the enterprise main office 100, at different physical locations either at or remote from the enterprise main office 100 and/or enterprise remote office 112, or any other suitable location or combination of locations.

The VPN server 108 is coupled to the enterprise server 104 and allows for secure communications between the enterprise main office 100 and the enterprise remote office 112, and between the enterprise main office 100 and any device 116, over the communication network 110. The VPN server 108 provides security by re-routing such communications through a trusted route over the communication network 110. The VPN server 108 can be software, hardware, or a combination of software and hardware. FIG. 1 shows the VPN server 108 as a single VPN server; however, the VPN server 108 can include more than one VPN server. FIG. 1 also shows the VPN server 108 and the enterprise server 104 as separate servers; however, the VPN server 108 and the enterprise server 104 can be combined into one server.

The communication network 110 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 1 shows the network 110 as a single network; however, the network 110 can include multiple interconnected networks listed above.

The enterprise remote office 112 can remotely connect to the enterprise main office 100 via the communication network 110. Although not shown, the enterprise remote office 112 can include an arrangement similar to that shown and described in connection with the enterprise main office 100. The enterprise remote office 112 includes at least one device (similar to device 102), an enterprise remote server (similar to enterprise server 104), and a VPN server or appliance 114. The enterprise remote office 112 can have its own physical storage medium (similar to physical storage medium 106) and/or can share the physical storage medium 106 at the enterprise main office 100. The VPN server 114 is coupled to the enterprise remote server and allows for secure communications between the enterprise remote office 112 and the enterprise main office 100, and between the enterprise remote office 112 and any device 116, over the communication network 110. The VPN server 114 is similar to that shown and described in connection with the VPN server 108. FIG. 1 shows one enterprise remote office 112; however, there can be more than one enterprise remote office 112.

Each device 116 can be any suitable client device that allows any enterprise user to remotely connect to the enterprise main office 100 and/or enterprise remote office 112 via the communication network 110. Each device 116 can include a desktop computer, a mobile computer, a tablet computer, a cellular device, or any other computing device having a processor and memory. Each device 116 can run VPN software, hardware, or a combination of software or hardware, which allows for secure communications between the device 116 and the enterprise main office 100, and between the device 116 and the enterprise remote office 112, over the communication network 110.

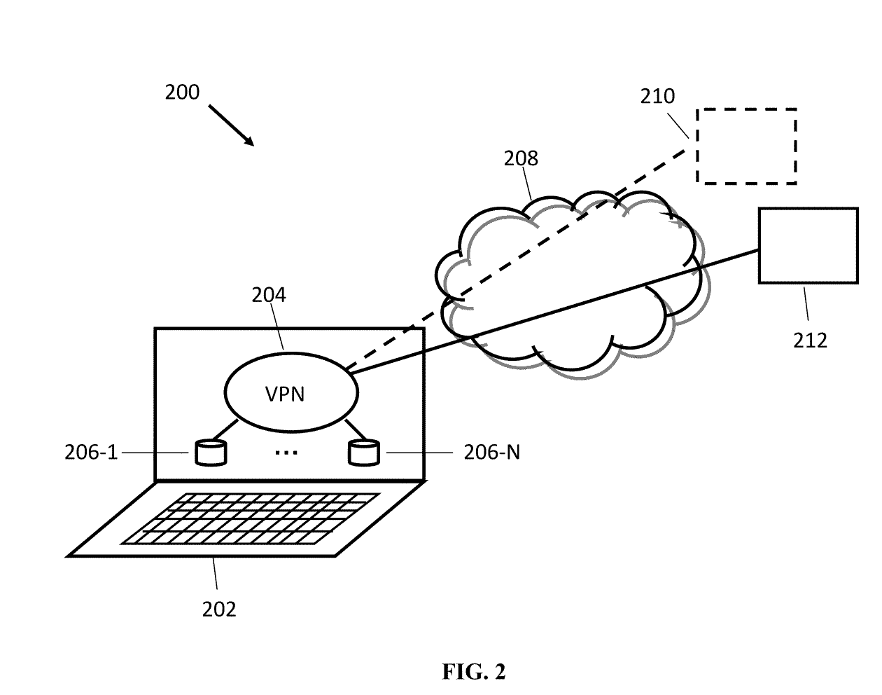

FIG. 2 illustrates a client device using a VPN in a networked communication system 200. A client device 202 (e.g., device 116) can remotely connect to the enterprise (e.g., enterprise main office 100 and/or enterprise remote office 112) by running VPN 204 on the client device 202. Through the VPN 204, the client device 202 can access at least one computer application 206 (e.g., computer application 206-1, . . . 206-N). Through any computer application 206, the client device 202 can access data from, or send data to, a storage medium (e.g., physical storage medium 106) at the enterprise. Because the client device 202 is running VPN 204, any computer application 206 being accessed on the client device 202 is tricked into thinking that the data is being accessed from, or being sent to, a storage medium 210. Instead, the data is actually being accessed from, or being sent to, a storage medium 212 at the enterprise. The VPN 204 provides a secure route for data to be communicated with the enterprise over the communication network 208 (e.g., communication network 110).

FIGS. 1 and 2 are shown and described in connection with a networked communication system for an enterprise that uses VPN. In accordance with an embodiment of the disclosed subject matter, the networked communication system of FIG. 1 can be used in the present invention. The invention can be implemented for an enterprise that supports VPN. For example, the use of policy wrappers for computer applications can be used in addition to, or in lieu of, the use of VPN. Alternatively, the invention can be implemented for an enterprise that does not support VPN.

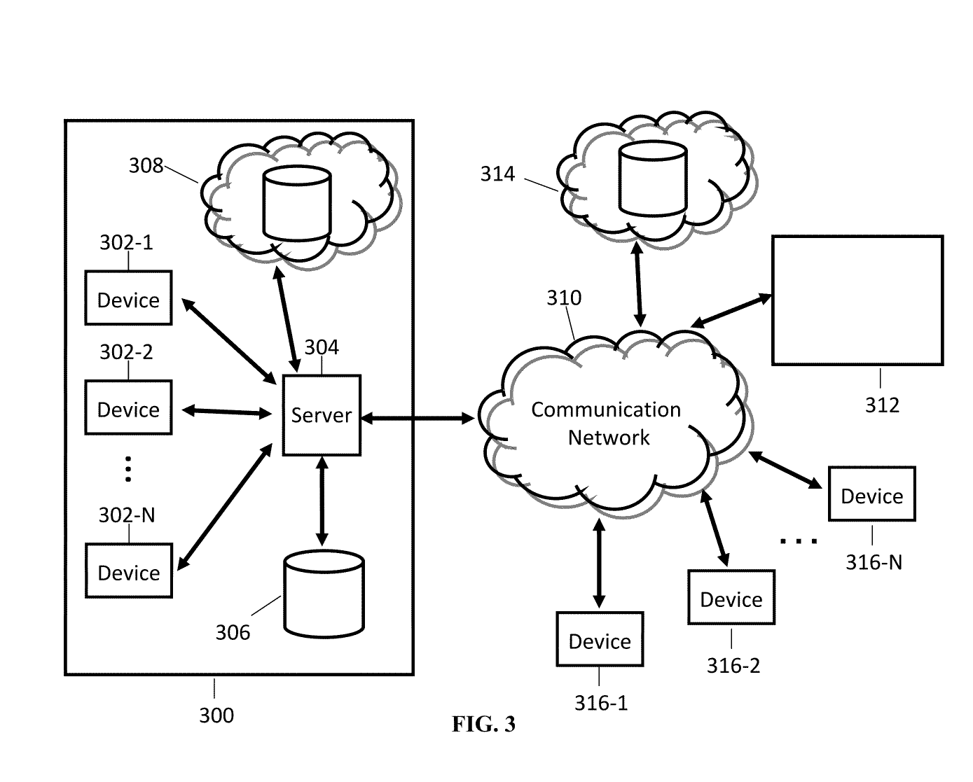

FIG. 3 illustrates a diagram of a networked communication system in accordance with an embodiment of the disclosed subject matter. FIG. 3 includes an enterprise main office 300, an enterprise remote office 312, at least one device 316 (e.g., device 316-1, 316-2, . . . 316-N), a communication network 310, and a cloud storage 314.

The enterprise main office 300 includes at least one device 302 (e.g., device 302-1, 302-2, . . . 302-N), an enterprise server 304, at least one physical storage medium 306, and a cloud storage 308. In one embodiment, each device 302 can be any suitable client device that allows any enterprise user to directly connect to the enterprise network. Each device 302 can include a desktop computer, a mobile computer, a tablet computer, a cellular device, or any other computing device having a processor and memory. In another embodiment, one or more of the devices 302 can include a network resource to which an enterprise user can connect, including a printer, a photocopier, or any other suitable network resource having a processor and memory.

Each device 302 can communicate with the enterprise server 304 to send data to, and to receive data from, another device 302 and/or other network nodes (including devices at the enterprise remote office 312 and/or device 316) across communication network 310. Although FIG. 3 shows each device 302 being directly coupled to the enterprise server 304, each device 302 can be connected to the enterprise server 304 via any other suitable device, communication network, or combination thereof. For example, each device 302 can be coupled to the enterprise server 304 via one or more routers, switches, access points, and/or communication networks (as described below in connection with communication network 310).

The enterprise server 304 is coupled to at least one physical storage medium 306 for the enterprise. Any enterprise user, from enterprise main office 300 (using any device 302), from enterprise remote office 312, and device 316, can store data in, and access data from, the physical storage medium 306 via the enterprise server 304. FIG. 3 shows the enterprise server 304 and the physical storage medium 306 as separate components; however, the enterprise server 304 and physical storage medium 306 can be combined together. FIG. 3 also shows the enterprise server 304 as a single server; however, the enterprise server 304 can include more than one enterprise server. FIG. 3 shows the physical storage medium 306 as a single physical storage medium; however, the physical storage medium 306 can include more than one physical storage medium. The physical storage media can be located in the same physical location as the enterprise main office 300, at the same physical location remote from the enterprise main office 300, at different physical locations either at or remote from the enterprise main office 300 and/or enterprise remote office 312, or any other suitable location or combination of locations.

The communication network 310 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 3 shows the network 310 as a single network; however, the network 310 can include multiple interconnected networks listed above.

The enterprise remote office 312 can remotely connect to the enterprise main office 300 via the communication network 310. Although not shown, the enterprise remote office 312 can include an arrangement similar to that shown and described in connection with the enterprise main office 300. The enterprise remote office 312 includes at least one device (similar to device 302) and an enterprise remote server (similar to enterprise server 304). The enterprise remote office 312 can have its own physical storage medium (similar to physical storage medium 306) and/or can share the physical storage medium 306 at the enterprise main office 300. FIG. 3 shows one enterprise remote office 312; however, there can be more than one enterprise remote office 312.

Each device 316 can be any suitable client device that allows any enterprise user to remotely connect to the enterprise main office 300 and/or enterprise remote office 312 via the communication network 310. Each device 316 can include a desktop computer, a mobile computer, a tablet computer, a cellular device, or any other computing device having a processor and memory. Each device 316 (in addition to each device 302 at the enterprise main office 300 and device at the enterprise remote office 312) can run one or more computer applications that applies policies from a policy wrapper associated with the computer applications to securely communicate to the enterprise over the communication network 310.

FIG. 3 shows two embodiments of cloud storage 308 and 314, which can be any suitable cloud storage. Cloud storage 308 is within the enterprise main office 300 and coupled to the enterprise server 304. Alternatively, there can be a cloud storage in the enterprise remote office 312, or in both the enterprise main office 300 and the enterprise remote office 312. Cloud storage 314 is external to the enterprise (e.g., enterprise main office 300 and enterprise remote office 312) and coupled to the communication network 310. Cloud storage 314 can be a dedicated storage for an enterprise, public storage for enterprise users' personal information, public storage for non-enterprise users, or any other suitable cloud storage or combination thereof. Cloud storage 308 and cloud storage 314 that is dedicated for an enterprise can store data generated by the enterprise main office 300, enterprise remote office 312, and any device 316, This cloud storage can store data with the restrictions, security measures, authentication measures, policies, and other features required by an enterprise. FIG. 3 shows the cloud storage 314 separate from the communication network 310; however, cloud storage 314 can be part of communication network 310 or another communication network. FIG. 3 shows one cloud storage 308 and one cloud storage 314; however, more than one cloud storage 308, more than one cloud storage 314, or any suitable combination thereof can be used. For a user's enterprise-related information and personal information, the same cloud storages or different cloud storages can be used.

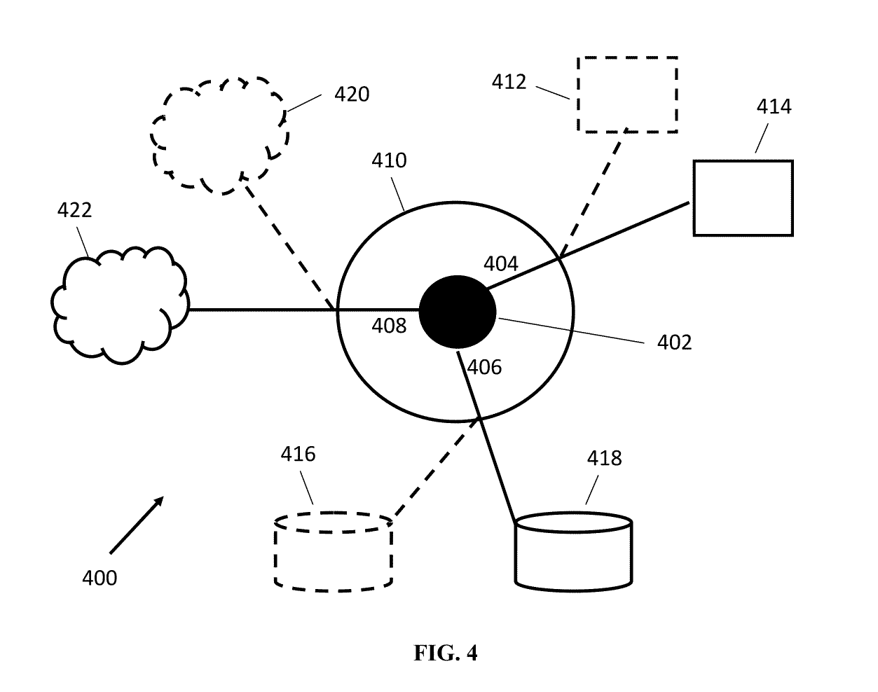

FIG. 4 illustrates a diagram 400 of the use of a policy wrapper for a computer application in accordance with certain embodiments of the disclosed subject matter. An enterprise user can access a computer application 402 on any computing device (e.g., device 116 and/or 316). The computer application 402 can include one or more APIs (e.g., API 404, 406, and 408). The APIs 404, 406, and 408 allow the user, using the computer application 402, to communicate over the communication network (e.g., communication network 110 and/or 310) with the enterprise (e.g., enterprise main office 100 and/or 300, enterprise remote office 112 and/or 312), cloud storage (e.g., cloud storage 314), or other network nodes or communication networks.

A policy wrapper 410 can be associated with the computer application 402. The policy wrapper 410 can specify how to handle the communication of the different API calls (via APIs 404, 406, and 408) over the communication network. The policy wrapper 410 can include policies that apply the same or different authentication, firewall, and encryption techniques on the different APIs 404, 406 and 408. The policy wrapper 410 can also specify the same or different re-routing, modification, or recording of IP packets, the storage of data, the displaying of data, the printing of data, or any other suitable data and/or actions on the different APIs 404, 406, and 408. The different types of data and/or actions can be treated the same or differently.

In one embodiment, by applying the policies specified in the policy wrapper 410, the computer application 402, through APIs 404, 406, and 408, can be tricked into thinking that the data and/or action is being communicated to one location when the data and/or action is actually being communicated to another location. For example, the computer application 402, through API 404, can be tricked into thinking that the data and/or action is being communicated to location 412, when the data and/or action is actually being communicated to location 414. The computer application 402, through API 406, can be tricked into thinking that the data and/or action is being communicated to location 416, when the data and/or action is actually being communicated to location 418. The computer application 402, through API 408, can be tricked into thinking that the data and/or action is being communicated to location 420, when the data and/or action is actually being communicated to location 422. The policy wrapper 410 provides a secure route for data and/or actions to be communicated over the communication network to one or more locations 414, 418, and 422.

The locations 414, 418, and 422 can be any suitable location or combination of locations The locations 414, 418, and 422 can be the same location or different locations, and can be within or external to the enterprise. For example, the locations 414, 418, and 422 can be any one or more of the devices 102/302, physical storage medium 106/306, or cloud storage 308 within the enterprise main office 100/300, similar components in the enterprise remote office 112/312, cloud storage 314, or any other suitable location or combination of locations.

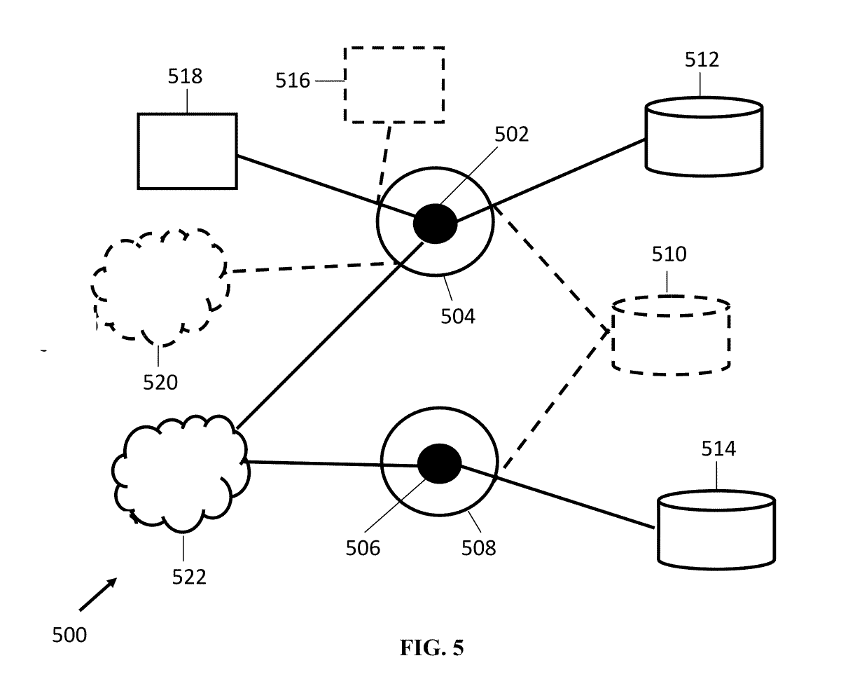

FIG. 5 illustrates a diagram 500 of the use of policy wrappers for two computer applications in accordance with certain embodiments of the disclosed subject matter. An enterprise user can access two computer applications 502 and 506 on any computing device (e.g., device 116 and/or 316). Each computer application 502 and 506 can include one or more APIs. For example, computer application 502 includes three APIs while computer application 506 includes two APIs. The APIs allow the user, using the computer application 502 or 506, to communicate over the communication network (e.g., communication network 110 and/or 310) with the enterprise (e.g., enterprise main office 100 and/or 300, enterprise remote office 112 and/or 312), cloud storage (e.g., cloud storage 314), or other network nodes or communication networks.

A policy wrapper can be associated with each computer application 502 and 506. For example, a policy wrapper 504 can be associated with computer application 502 and a policy wrapper 508 can be associated with computer application 506. Each policy wrapper 504 and 508 can specify how to handle the communication of the different API calls for the respective computer applications 502 and 506 over the communication network. The policy wrappers 504 and 508 can be similar to that shown and described in connection with policy wrapper 410 (FIG. 4).

In one embodiment, by applying the policies specified in the policy wrappers 504 and 508, the respective computer applications 502 and 506, through their APIs, can be tricked into thinking that the data and/or actions are being communicated to one location when the data and/or actions are actually being communicated to another location. For example, the computer application 502, through its APIs, can be tricked into thinking that the data and/or actions are being communicated to locations 510, 516, and/or 520, when the data and/or actions are actually being communicated to respective locations 512, 518, and 522. The computer application 506, through one of its APIs, can be tricked into thinking that the data and/or action is being communicated to location 510, when the data and/or action is actually being communicated to location 514. In another embodiment, the computer application 506, through another of its APIs, can communicate the data and/or action to location 522. The policy wrappers 504 and 508 can provide a secure route for data and/or actions to be communicated over the communication network to one or more locations 512, 514, 518 and 522. The policy wrapper 508 can also provide an unsecure route for certain data and/or actions to be communicated over the communication network to location 522.

The locations 512, 514, 518, and 522 can be any suitable location or combination of locations In one embodiment, the locations 512, 514, and 518 can be the same location or different locations, and can be within or external to the enterprise. For example, the locations 512, 514, and 518 can be any one or more of the devices 102/302, physical storage medium 106/306, or cloud storage 308 within the enterprise main office 100/300, similar components in the enterprise remote office 112/312, cloud storage 314 designated for the enterprise, or any other suitable location or combination of locations. In another embodiment, the location 522 can be different from locations 512, 514, and 518, and can be external to the enterprise. For example, the location 522 can be cloud storage 314 for public storage.

The policy wrappers 504 and/or 508 can include policies that can distinguish between a user's enterprise-related information and the user's personal information. For example, the policies can specify that certain computer applications provide only enterprise-related information (e.g., an enterprise's data management system, e-mail communication system, time entry system), or that certain data and/or actions within a computer application provide enterprise-related information. Depending on whether the information is enterprise-related or personal, the policy wrapper can decide how to handle the information. For example, enterprise-related information may be securely re-routed to a location within the enterprise while personal information may be unsecurely routed to a location external to the enterprise.

FIGS. 4 and 5 are merely exemplary. In accordance with an embodiment of the invention, any suitable number and/or combinations of computer applications, policy wrappers, APIs, and/or locations can be implemented.

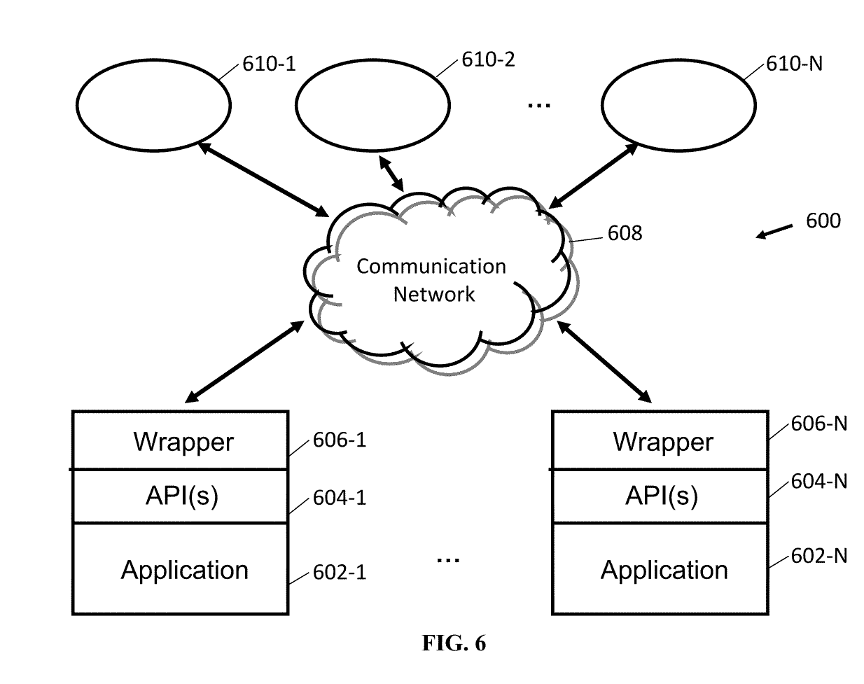

FIG. 6 illustrates a diagram 600 of a networked communication system implementing policy wrappers for computer applications in accordance with certain embodiments of the disclosed subject matter. One or more computing devices (e.g., devices 116/316 can include one or more computer applications 602 (e.g., applications 602-1, . . . 602-N). Each application 602 can have one or more APIs 604 (e.g., application 602-1 can have associated API(s) 604-1, . . . application 602-N can have associated API(s) 604-N) that allow the application 602 to communicate data and/or actions over a communication network 608. Each application 602 can also have one or more policy wrappers 606 (e.g., application 602-1 can have associated policy wrapper 606-1, . . . application 602-N can have associated policy wrapper 606-N). Each policy wrapper 606 can include policies that specify how to handle the communication of the data and/or actions from the API(s) 604 over the communication network 608 to one or more locations 610 (e.g., locations 610-1, 610-2, . . . 610-N). Each location 610 can be within or external to the enterprise. For example, each location 610 can be device 102/302, physical storage medium 106/306, or cloud storage 308 within the enterprise main office 100/300, similar components in the enterprise remote office 112/312, cloud storage 314, or any other suitable location or combination of locations.

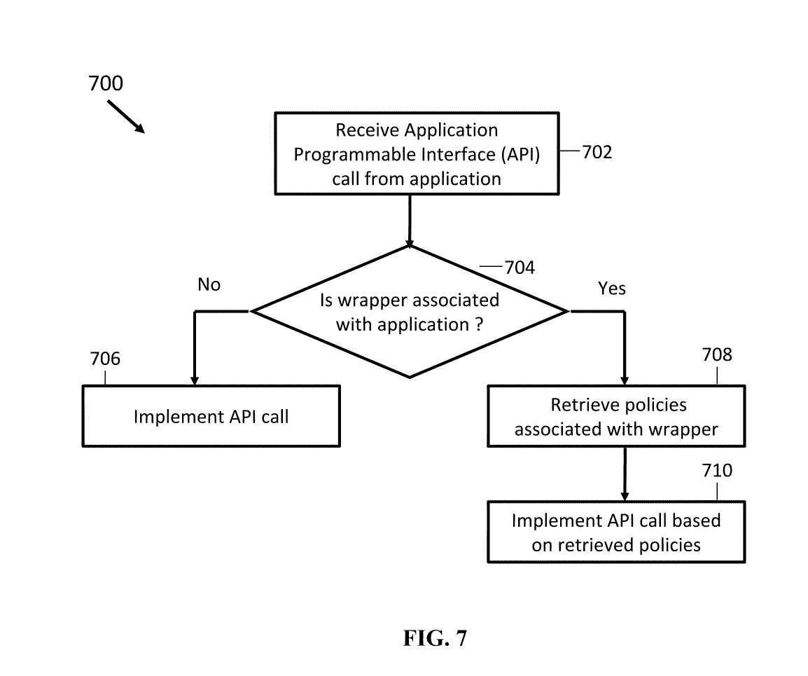

FIG. 7 illustrates a flow diagram 700 illustrating how policy wrappers are applied to computer applications in accordance with certain embodiments of the disclosed subject matter. At step 702, a computing device (e.g., device 116/316) receives an API call from a computer application. At step 704, the computing device determines whether there is a policy wrapper associated with the computer application. If no policy wrapper is associated with the computer application, the API call is implemented at step 706. For example, the computing device can communicate information over the communication network without any additional security applied to the information. In addition the computing device does not communicate with the enterprise. If a policy wrapper is associated with the computer application, the computing device retrieves the policies associated with the policy wrapper at step 708. At step 710, the API call is implemented based on the retrieved policies. For example, the computing device can securely communicate information over the communication network to the enterprise.

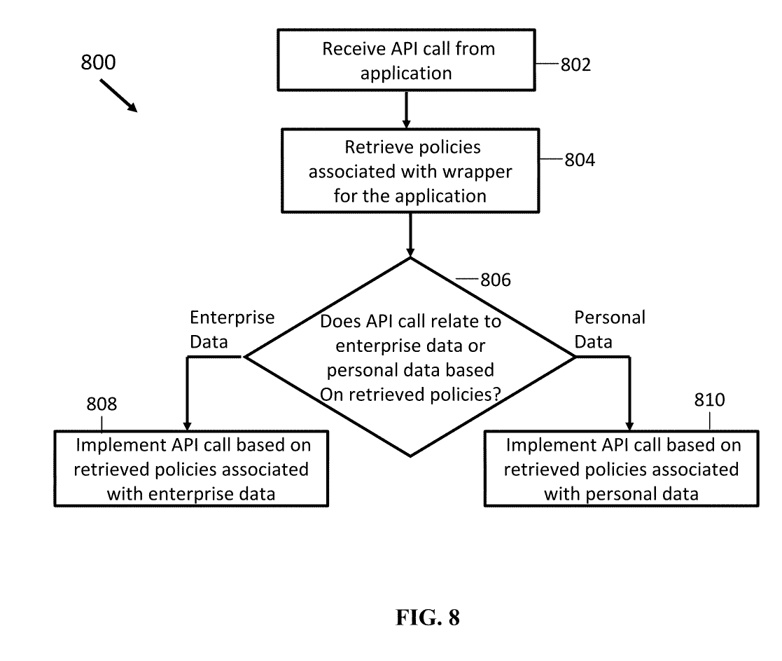

FIG. 8 illustrates a flow diagram 800 illustrating how policy wrappers are applied to computer applications in accordance with certain embodiments of the disclosed subject matter. At step 802, a computing device (e.g., device 116/316) receives an API call from a computer application. At step 804, the computing device retrieves the policies associated with the policy wrapper for the computer application. At step 806, the computing device determines whether the API call relates to enterprise data or a user's personal data based on the retrieved policies. For example, the policies can specify that certain computer applications provide only enterprise-related information (e.g., an enterprise's data management system, e-mail communication system, time entry system), or that certain data and/or actions within a computer application provide enterprise-related information. If the API call relates to enterprise data, the API call is implemented based on the retrieved policies associated with enterprise data at step 808. For example, the computing device can securely communicate information over the communication network to the enterprise. The information can be communicated to a designated location in the enterprise (e.g., device 102/302, physical storage medium 106/306, or cloud storage 308 within the enterprise main office 100/300, similar components in the enterprise remote office 112/312, cloud storage 314 designated for the enterprise). If the API call relates to a user's personal data, the API call is implemented based on the retrieved policies associated with personal data at step 810. For example, the computing device can communicate information over the communication network without any additional security applied to the information. The information can be communicated to another designated location external to the enterprise (e.g., cloud storage 314 for public storage).

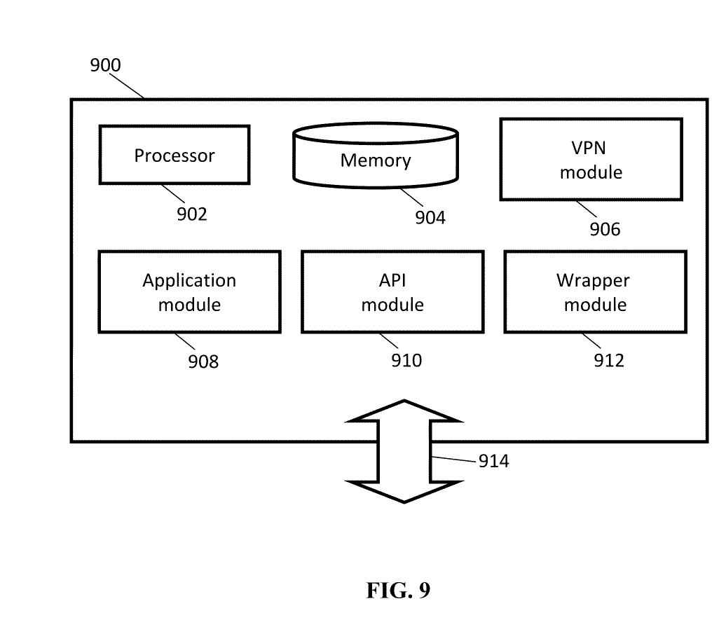

FIG. 9 illustrates a block diagram of a client device 900 (e.g., device 116/316) in accordance with certain embodiments of the disclosed subject matter. The client device 900 can include at least a processor 902, at least one memory 904, a VPN module 906, a computer application module 908, an API module 910, and a policy wrapper module 912.

A VPN module 906 is configured to allow an enterprise user at device 900 to remotely connect to the enterprise (e.g., enterprise main office 100/300, enterprise remote office 112/312) over the communication network (e.g., communication network 110/310). The VPN module 906 can further be configured to allow any enterprise user at device 900 to communicate information with device 102/302, server 104/304, physical storage medium 106/306, cloud storage 308, or cloud storage 314 designated for the enterprise. FIG. 9 shows the device 900 having the VPN module 906; however, the invention can be implemented with or without the VPN or VPN module 906.

A computer application module 908 is configured to allow an enterprise user at device 900 to access one or more computer applications. The computer application can require the communication of information local or external to the device 900. The computer application can require the communication of information over the communication network within or external to the enterprise. The computer application can allow the enterprise user to generate and/or access enterprise-related information or personal information.

An API module 910 is configured to allow an enterprise user at device 900 to communicate information from a computer application local or external to the device 900. The API module 910 can support the re-routing, modification, or recording of IP packets, the storage of data, the displaying of data, the printing of data, or any other suitable data and/or actions through one or more APIs associated with each computer application.

A policy wrapper module 912 is configured to associate one or more policy wrappers with one or more computer applications. Each policy wrapper can have associated with it one or more policies that can specify how to handle the communication of the different API calls from different computer applications over the communication network. The policy wrapper module 912 can further be configured to apply the one or more policies to each type or group of API calls for each computer application or group of computer applications. In one embodiment, the policy wrapper module 912 can be configured to perform the steps shown and described in connection with FIGS. 7 and 8.

The VPN module 906, computer application module 908, API module 910, and policy wrapper module 912 can be implemented in software, which may be stored in memory 904. FIG. 9 shows client device 900 having separate modules 906, 908, 910, and 912 that perform the above-described operations in accordance with certain embodiments of the disclosed subject matter. In other embodiments of the invention, client device 900 can include additional modules, less modules, or any other suitable combination of modules that perform any suitable operation or combination of operations. The memory 904 can be a non-transitory computer readable medium, flash memory, a magnetic disk drive, an optical drive, a programmable read-only memory (PROM), a read-only memory (ROM), or any other memory or combination of memories. The software runs on a processor 902 capable of executing computer instructions or computer code. The processor 902 might also be implemented in hardware using an application specific integrated circuit (ASIC), programmable logic array (PLA), field programmable gate array (FPGA), or any other integrated circuit.

An interface 914 provides an input and/or output mechanism to communicate over a network. The interface 914 enables communication with servers, as well as other network nodes in the communication network 110/310. The interface 914 is implemented in hardware to send and receive signals in a variety of mediums, such as optical, copper, and wireless, and in a number of different protocols some of which may be non-transient.

The client device 900 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The client device 900 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities. The client device 900 is configured with one or more processors 902 that process instructions and run software that may be stored in memory. The processor 902 also communicates with the memory and interfaces to communicate with other devices. The processor 902 can be any applicable processor such as a system-on-a-chip that combines a CPU, an application processor, and flash memory. The client device 900 can also provide a variety of user interfaces such as a keyboard, a touch screen, a trackball, a touch pad, and/or a mouse. The client device 900 may also include speakers and a display device in some embodiments.

The server 104/304 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 104/304 (in enterprise main office 100/300, and similar server in enterprise remote office 112/312). A task can be a software process that performs a specific function related to system control or session processing. Three types of tasks operate within the server 104/304 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 104 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 104/304 by monitoring the various software and hardware components of the server 104/304. Recovery control task subsystem is responsible for executing a recovery action for failures that occur in the server 104/304 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 104/304 with an ability to set, retrieve, and receive notification of server configuration parameter changes and is responsible for storing configuration data for the applications running within the server 104/304. A resource management subsystem is responsible for assigning resources (e.g., processor and memory capabilities) to tasks and for monitoring the task's use of the resources.

In some embodiments, the server 104/304 can reside in a data center and form a node in a cloud computing infrastructure. The server 104/304 can also provide services on demand. A module hosting a client is capable of migrating from one server to another server seamlessly, without causing program faults or system breakdown. The server 104/304 on the cloud can be managed using a management system.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A non-transitory computer readable medium having executable instructions operable to cause a client device to:
receive an application programming interface (API) call to communicate information from a computer application to an enterprise over a communication network;
determine whether the computer application has associated with it a policy wrapper comprising a policy that specifies how to handle the API call from the computer application; and
when the computer application has associated with it the policy wrapper:
retrieve the policy for the policy wrapper associated with the computer application, and
implement the API call by securely communicating the information from the computer application to the enterprise over the communication network based on the policy.

2. The computer-readable medium of claim 1, further comprising executable instructions operable to cause the client device to receive the API call to perform one of routing IP packets, storing data, displaying data, and printing data.

3. The computer-readable medium of claim 1, further comprising executable instructions operable to cause the client device to send authentication information to the enterprise over the communication network prior to implementing the API call.

4. The computer-readable medium of claim 1, wherein the policy specifies an encryption technique for securely communicating the information from the computer application to the enterprise over the communication network.

5. The computer-readable medium of claim 1, wherein the policy specifies at least one location to which the API call communicates the information from the computer application, wherein the at least one location is one of an enterprise's client device, an enterprise's physical storage medium, and an enterprise's cloud storage.

6. The computer-readable medium of claim 1, further comprising executable instructions operable to cause the client device to:
receive a second API call to communicate second information from the computer application over the communication network;
determine whether the second information relates to enterprise data or personal data based on a second policy for the policy wrapper associated with the computer application;
when the second information is enterprise data, implement the second API call by securely communicating the second information from the computer application to a first location in the enterprise over the communication network based on the second policy; and
when the second information is personal data, implement the second API call by communicating the second information from the computer application to a second location external to the enterprise over the communication network based on the second policy.

7. The computer-readable medium of claim 1, further comprising executable instructions operable to cause the client device to:
receive a second API call to communicate second information from a second computer application to the enterprise over the communication network;
determine whether the second computer application has associated with it a second policy wrapper comprising a second policy that specifies how to handle the second API call from the second computer application, wherein the second policy wrapper is different from the first policy wrapper; and
when the second computer application has associated with it the second policy wrapper:
retrieve the second policy for the second policy wrapper associated with the second computer application, and
implement the second API call by securely communicating the second information from the second computer application to the enterprise over the communication network based on the second policy.

8. An apparatus comprising:
one or more interfaces configured to provide communication with an enterprise via a communication network; and
a processor, in communication with the one or more interfaces, and configured to run a module stored in memory that is configured:
to receive an application programming interface (API) call to communicate information from a computer application to the enterprise over the communication network,
to determine whether the computer application has associated with it a policy wrapper comprising a policy that specifies how to handle the API call from the computer application, and
when the computer application has associated with it the policy wrapper:
retrieve the policy for the policy wrapper associated with the computer application, and
implement the API call by securely communicating the information from the computer application to the enterprise over the communication network based on the policy.

9. The apparatus of claim 8, wherein the module is further configured to receive the API call to perform one of routing IP packets, storing data, displaying data, and printing data.

10. The apparatus of claim 8, wherein the module is further configured to send authentication information to the enterprise over the communication network prior to implementing the API call.

11. The apparatus of claim 8, wherein the policy specifies an encryption technique for securely communicating the information from the computer application to the enterprise over the communication network.

12. The apparatus of claim 8, wherein the policy specifies at least one location to which the API call communicates the information from the computer application, wherein the at least one location is one of an enterprise's client device, an enterprise's physical storage medium, and an enterprise's cloud storage.

13. The apparatus of claim 8, wherein the module is further configured to:
receive a second API call to communicate second information from the computer application over the communication network;
determine whether the second information relates to enterprise data or personal data based on a second policy for the policy wrapper associated with the computer application;
when the second information is enterprise data, implement the second API call by securely communicating the second information from the computer application to a first location in the enterprise over the communication network based on the second policy; and
when the second information is personal data, implement the second API call by communicating the second information from the computer application to a second location external to the enterprise over the communication network based on the second policy.

14. The apparatus of claim 8, wherein the module is further configured to:
receive a second API call to communicate second information from a second computer application to the enterprise over the communication network;
determine whether the second computer application has associated with it a second policy wrapper comprising a second policy that specifies how to handle the second API call from the second computer application, wherein the second policy wrapper is different from the first policy wrapper; and
when the second computer application has associated with it the second policy wrapper:
retrieve the second policy for the second policy wrapper associated with the second computer application, and
implement the second API call by securely communicating the second information from the second computer application to the enterprise over the communication network based on the second policy.

15. A method comprising:
receiving an application programming interface (API) call to communicate information from a computer application to an enterprise over a communication network;
determining whether the computer application has associated with it a policy wrapper comprising a policy that specifies how to handle the API call from the computer application; and
when the computer application has associated with it the policy wrapper:
retrieving the policy for the policy wrapper associated with the computer application, and
implementing the API call by securely communicating the information from the computer application to the enterprise over the communication network based on the policy.

16. The method of claim 15 further comprising receiving the API call to perform one of routing IP packets, storing data, displaying data, and printing data.

17. The method of claim 15 further comprising sending authentication information to the enterprise over the communication network prior to implementing the API call.

18. The method of claim 15, wherein the policy specifies at least one location to which the API call communicates the information from the computer application, wherein the at least one location is one of an enterprise's client device, an enterprise's physical storage medium, and an enterprise's cloud storage.

19. The method of claim 15, further comprising:
receiving a second API call to communicate second information from the computer application over the communication network;
determining whether the second information relates to enterprise data or personal data based on a second policy for the policy wrapper associated with the computer application;
when the second information is enterprise data, implementing the second API call by securely communicating the second information from the computer application to a first location in the enterprise over the communication network based on the second policy; and
when the second information is personal data, implementing the second API call by communicating the second information from the computer application to a second location external to the enterprise over the communication network based on the second policy.

20. The method of claim 15, further comprising:
receiving a second API call to communicate second information from a second computer application to the enterprise over the communication network;
determining whether the second computer application has associated with it a second policy wrapper comprising a second policy that specifies how to handle the second API call from the second computer application, wherein the second policy wrapper is different from the first policy wrapper; and
when the second computer application has associated with it the second policy wrapper:
retrieving the second policy for the second policy wrapper associated with the second computer application, and
implementing the second API call by securely communicating the second information from the second computer application to the enterprise over the communication network based on the second policy.
